(19) United States
(12) Patent Application Publication
(10) Pub. No.: US 2017/0372695 A1
(43) Pub. Date: Dec. 28, 2017

(54) INFORMATION PROVIDING SYSTEM

(71) Applicant: MITSUBISHI ELECTRIC CORPORATION, Tokyo (JP)

(72) Inventors: Takumi TAKEI, Tokyo (JP); Yuki FURUMOTO, Tokyo (JP); Tomohiro NARITA, Tokyo (JP); Tatsuhiko SAITO, Tokyo (JP)

(73) Assignee: MITSUBISHI ELECTRIC CORPORATION, Tokyo (JP)

(21) Appl. No.: 15/548,154

(22) PCT Filed: Mar. 18, 2015
(86) PCT No.: PCT/JP2015/058073

§ 371 Date: Aug. 2, 2017

(51) Int. Cl. G10L 15/187; G06F 17/27; G06F 17/30; G10L 15/22; G10L 15/08

(52) U.S. Cl. CPC G10L 15/187; G06F 17/30696; G10L 15/22; G06F 17/2795; G06F 17/30684; G10L 2015/088

(57) ABSTRACT

When the number of characters displayable on a character display area of a display is restricted, the information providing system generates a first recognition object word from information of object to be provided. At the same time, the information providing system generates a second recognition object word by using whole of a character string which is obtained by shortening the first recognition object word to have the specified character number when its number of characters exceeds a specified character number, to thereby recognize a speech voice by a user, using the first recognition object word and the second recognition object word.

### TECHNICAL FIELD

The present invention relates to an information providing system for providing information related to a keyword spoken by a user among keywords related to pieces of providing object information.

### BACKGROUND ART

Conventionally, there are known information providing devices for providing information desired and selected by a user from among information acquired through distribution or the like.

For example, an information providing device according to Patent Literature 1 extracts keywords by performing language analysis on text information of a content distributed from outside, displays the keywords on a screen or outputs the keywords by voice as choices, and provides a content linked to a keyword when a user selects the keyword by voice input.

Further, there are known dictionary data generation devices which generates dictionary data for voice recognition used in a voice recognition device which recognizes an input command on the basis of a voice spoken by a user.

For example, a dictionary data generation device according to Patent Literature 2 determines the number of characters of keyword displayable on a display device for displaying a keyword, extracts a character string within that number of characters from text data corresponding to an input command to thereby set the character string as a keyword, and generates dictionary data by associating feature amount data of a voice corresponding to the keyword with a content data for specifying processing details corresponding to the input command.

### CITATION LIST

### Patent Literature

Patent Literature 1: Japanese Patent Application Laid-open No.2004-334280

Patent Literature 2: International Application Publication No. WO/2006/093003

### SUMMARY OF INVENTION

### Technical Problem

However, in a conventional art as exemplified by Patent Literature 1, no consideration is given to the restriction in the number of display characters when as keyword is displayed on a screen to a user as a choice. Thus, when the number of characters displayable on the screen is limited, there is a case that only a part of the keyword can be displayed. This may result in that the user cannot precisely recognize the keyword and thus cannot speak the keyword correctly, and as a result, there is a problem that it becomes unable to provide the content that the user wishes to select through speech.

It is noted that, with respect to a dictionary data generation device according to Patent Literature 1, it is described that a word in synonymic relation to the keyword extracted from a content can be added, or a part of the keyword can be deleted; however, mere addition or deletion of the keyword without considering the restriction in the number of the characters may possibly result in exceeding the number of characters displayable on the screen, like the above, so that the above problem is not solved.

In particular, in a case of using a content distributed from outside, because the content has a feature that it changes from moment to moment and thus, the details of the content to be distributed is unknown at the side of the information providing device. Thus, it is difficult to ensure a sufficient character display area in advance.

Further, in the conventional art as exemplified by Patent Literature 2, although consideration is given to the number of displayable characters, a voice recognition keyword is generated by deleting a part of a character string on a part of speech basis, so that there is a possibility of lacking significant information for representing the content. Accordingly, there is a possibility that the user cannot precisely grasp what content is to be presented when what keyword is spoken, and is thus unable to access a desired content. For example, when the keyword “America” is set for a content related to “American President”, dissociation between the content and the keyword occurs.

In particular, in the case where the text information of the content is outputted by voice, the user is expected to speak using the voice which is actually heard at the time of selecting a content. For that reason, in order to help the user get an understanding about a recognition object word, it is effective that not only a proper keyword most likely indicative of the details of the content outputted by voice, but also a word which has small different from the proper keyword in at least one of its meaning and its character string, are included as the recognition object words. Furthermore, in consideration of displaying the keyword on the screen, it is effective that the content that the user desires and attempts to select can be provided even if the keyword is falsely spoken because of influence of the deletion in the character string.

This invention is made to solve the problems as described above, and an object thereof is to make it possible to provide information that the user desires and attempts to select, even when the number of characters displayable on the screen is limited, to thereby enhance operability and convenience.

### Solution to Problem

An information providing system according to the invention includes: an acquisition unit acquiring information to be provided from an information source; a generation unit generating a first recognition object word from the information acquired by the acquisition unit, and generating a second recognition object word by using whole of a character string which is obtained by shortening the first recognition object word to have a specified character number when the number of characters of the first recognition object word exceeds the specified character number; a storage unit storing the information acquired by the acquisition unit, being associated with the first recognition object word and the second recognition object word generated by the generation unit; a voice recognition unit recognizing a speech voice by a user to output a recognition result character string; and a control unit outputting the first recognition object word or the second recognition object word which is generated by the generation unit and is composed of a character string whose number of characters is not more than the specified character number, to a display unit, and acquiring, when the recognition result character string outputted from the voice recognition unit coincides with the first recognition object word or the second recognition object word, the information associated with the first recognition object word or the second recognition object word from the storage unit, and outputting the acquired information to the display unit or an audio output unit.

### ADVANTAGEOUS EFFECTS OF INVENTION

According to the present invention, the first recognition object word is generated from provided information, and in addition, the second recognition object word is generated by using whole of the characters of the character string obtained by shortening the first recognition object word to have a specific number of characters. Thus, even when a user, to whom the first recognition object word or the second recognition object word composed of a character string whose number of characters is not more than the specified character number is presented, falsely recognizes the presented character string and then speaks a word other than the first recognition object word, the user can perform recognition on the basis of the second recognition object word. Accordingly, it becomes possible to provide information that the user desires and attempts to select, to thereby enhance operability and convenience.

### BRIEF DESCRIPTION OF DRAWINGS

FIG. 1 is a diagram schematically illustrating an information providing system and peripheral devices thereof, according to Embodiment 1 of the invention;

FIG. 2 is a diagram illustrating a method of providing information by the information providing system according to Embodiment 1, in which a case where a specified character number is five is shown;

FIG. 3 is a diagram illustrating a method of providing information by the information providing system according to Embodiment 1, in which a case where a specified character number is five is shown;

FIG. 4 is a schematic diagram showing a main hardware configuration of the information providing system and the peripheral devices thereof, according to Embodiment 1 of the invention;

FIG. 5 is a functional block diagram showing a configuration example of the information providing system according to Embodiment 1;

FIG. 6 is a diagram showing an example of a first recognition object word, a second recognition object word and a content which are stored in a storage unit;

FIG. 7 is a flowchart showing operations of the information providing system according to Embodiment 1, in which operations at the time of acquiring a content are shown;

FIG. 8 is a flowchart showing operations of the information providing system according to Embodiment 1, in which operations from when a keyword is presented until the content is provided are shown; and

FIG. 9 is a functional block diagram showing a modified example of the information providing system according to Embodiment 1.

### DESCRIPTION OF EMBODIMENTS

Hereinafter, for illustrating the invention in more detail, embodiments for carrying out the invention will be described with reference to the accompanying drawings.

It is noted that, in the following embodiments, the information providing system according to the invention will be described with a case, as an example, where it is applied to an in-vehicle device mounted on a moving object such as a vehicle; however, the system may be applied to, other than the in-vehicle device, a PC (Personal Computer), a tablet PC, or a portable information terminal such as a smartphone, etc.

### Embodiment 1

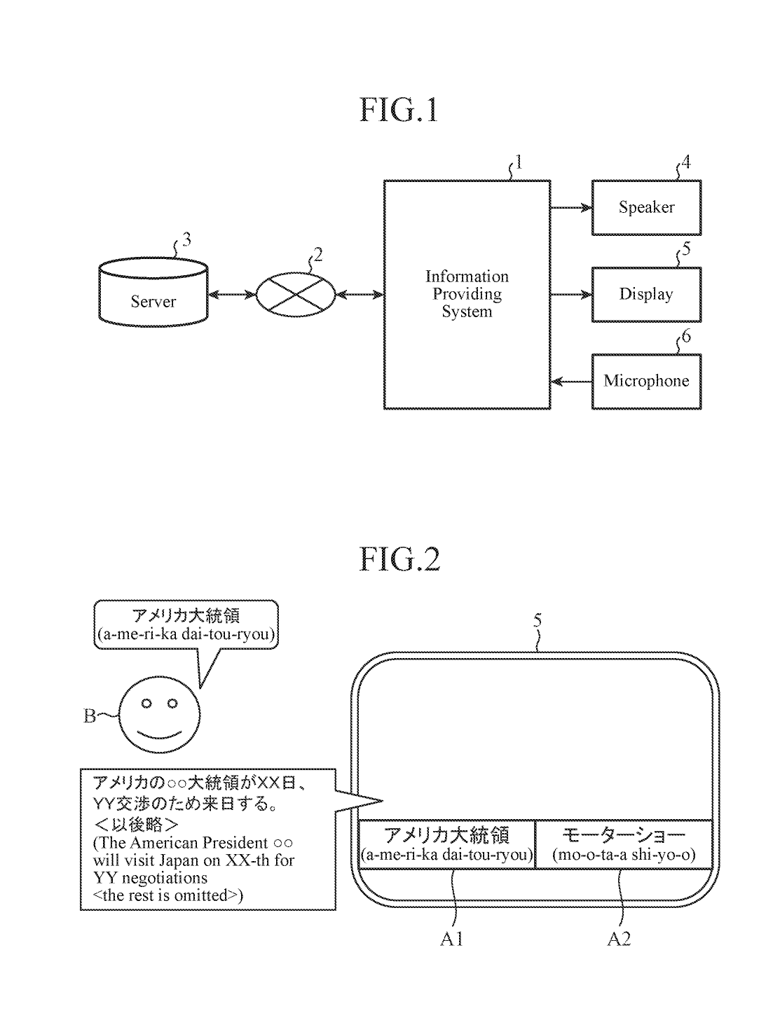

FIG. 1 is a diagram schematically illustrating an information providing system 1 and peripheral devices thereof, according to Embodiment 1 of the present invention.

The information providing system 1 acquires a content from an information source, such as a server 3, etc., through a network 2, and extracts keywords related to the content, and then presents the keywords to a user by displaying them on a screen of a display 5. When a keyword is spoken by the user, the speech voice is inputted through a microphone 6 to the information providing system 1. Using a recognition object word generated from the keywords related to the content, the information providing system 1 recognizes the keyword spoken by the user, and then provides to the user, the content related to the recognized keyword by displaying it on the screen of the display 5 or by outputting it by voice through a speaker 4.

The display 5 is a display unit, and the speaker 4 is an audio output unit.

For example, when the information providing system 1 is an in-vehicle device, the number of characters displayable on the screen of the display 5 is limited because of the presence of a guide line, etc. in which display content is restricted during traveling. Also, when the information providing system 1 is a portable information terminal, the number of displayable characters is limited because the display 5 is small in size, low in resolution or likewise.

Hereinafter, the number of characters displayable on the screen of the display 5 is referred to as “specified character number”.

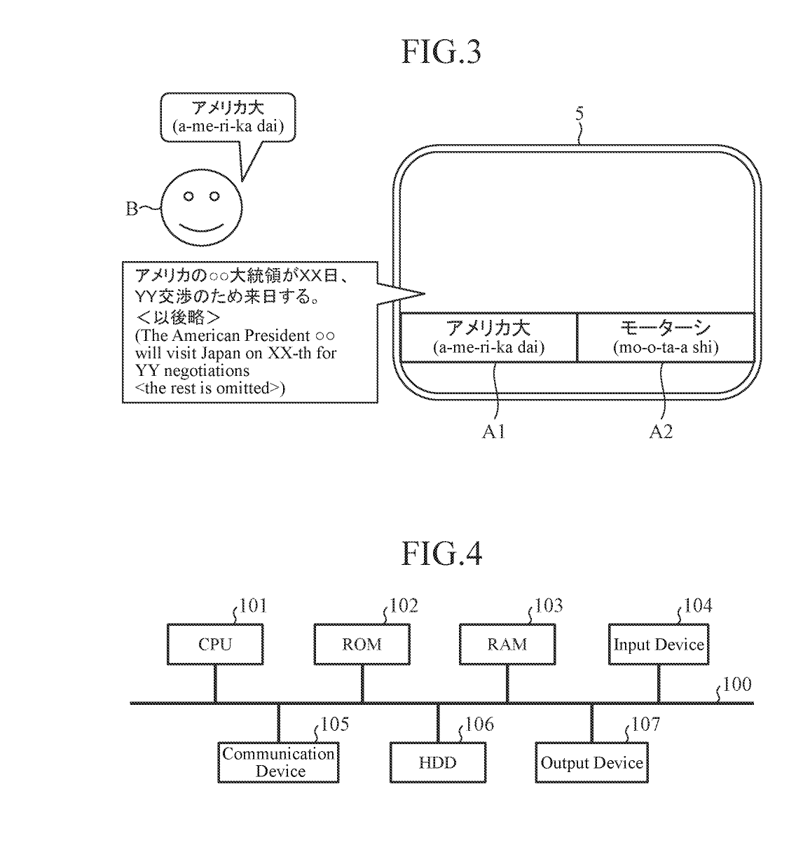

Here, using FIG. 2 and FIG. 3, a method of providing information by the information providing system 1 according to Embodiment 1 will be described schematically. FIG. 2 shows a case where the specified character number displayable in each of the character display areas A1, A2 of the display 5 is seven, and FIG. 3 shows a case where the specified character number is five.

Let's assume the information providing system 1 which provides news information as shown in FIG. 2 and FIG. 3 as a content. The news headline is assumed to be “The American President, To Visit Japan On XX-th” and the body of the news is assumed to be “The American President OO will visit Japan on XX-th for YY negotiations <the rest is omitted>”. It is noted that, for convenience of description, the following portion in the body of the news is represented as <the rest is omitted>.

In the case of this news, the keyword that represents the details of the news is, for example, “American President” (“a-me-ri-ka dai-too-ryoo” in Japanese), and the recognition object word is, for example, “a-me-ri-ka dai-tou-ryou (a-me-ri-ka dai-too-ryoo, in Japanese pronunciation)”. Here, the notation ad the pronunciation of the recognition object word will be written in the form of “Notation (Pronunciation)”.

In FIG. 2, the number of characters of the keyword “a-me-ri-ka dai-tou-ryou” is not more than the specified character number of seven, so that the information providing system 1 displays the keyword “a-me-ri-ka dai-tou-ryou” without change in the character display area A1. The recognition object word corresponding to the keyword “a-me-ri-ka dai-tou-ryou” is “a-me-ri-ka dai-tou-ryou (a-me-ri-ka dai-too-ryoo)” . When a user B speaks “a-me-ri-ka dai-tou-ryou (a-me-ri-ka dai-too-ryoo)”, the information providing system 1 recognizes, using the recognition object word, the keyword spoken by the user B, and then outputs by voice through the speaker 4, the body of the news related to recognized keyword, namely, “The American President OO will visit Japan on XX-th for YY negotiations <the rest is omitted>”. In addition to outputting the voice, or instead of outputting the voice, the information providing system 1 may display the news headline, a part of the body of the news (its beginning part, for example), or the like, on the display 5.

On the other hand, in FIG. 3, because the specified character number is five, the number of characters of the keyword “a-me-ri-ka dai-tou-ryou” exceeds the specified character number. In this case, the information providing system 1 displays the character string of “a-me-ri-ka dai” which is obtained by shortening the keyword to have the specified character number, in the character display area A1. The recognition object words corresponding to the keyword “a-me-ri-ka dai” are a first recognition object word “a-me-ri-ka dai-tou-ryou (a-me-ri-ka dai-too-ryoo)”, and a second recognition object word “a-me-ri-ka dai (a-me-ri-ka dai)”, and the like. When the user B speaks “a-me-ri-ka dai-tou-ryou (a-me-ri-ka dai-too-ryoo)” or “a-me-ri-ka dai (a-me-ri-ka dai)”, the information providing system 1 recognizes, using the recognition object words, the keyword spoken by the user B, and then outputs by voice, or displays on the screen, the body of the news related to the recognized keyword, like in the case of FIG. 2.

It is noted that in the cases in FIG. 2 and FIG. 3, two character display areas A1, A2 are provided for displaying the keywords; however, the number of character display areas is not limited to two.

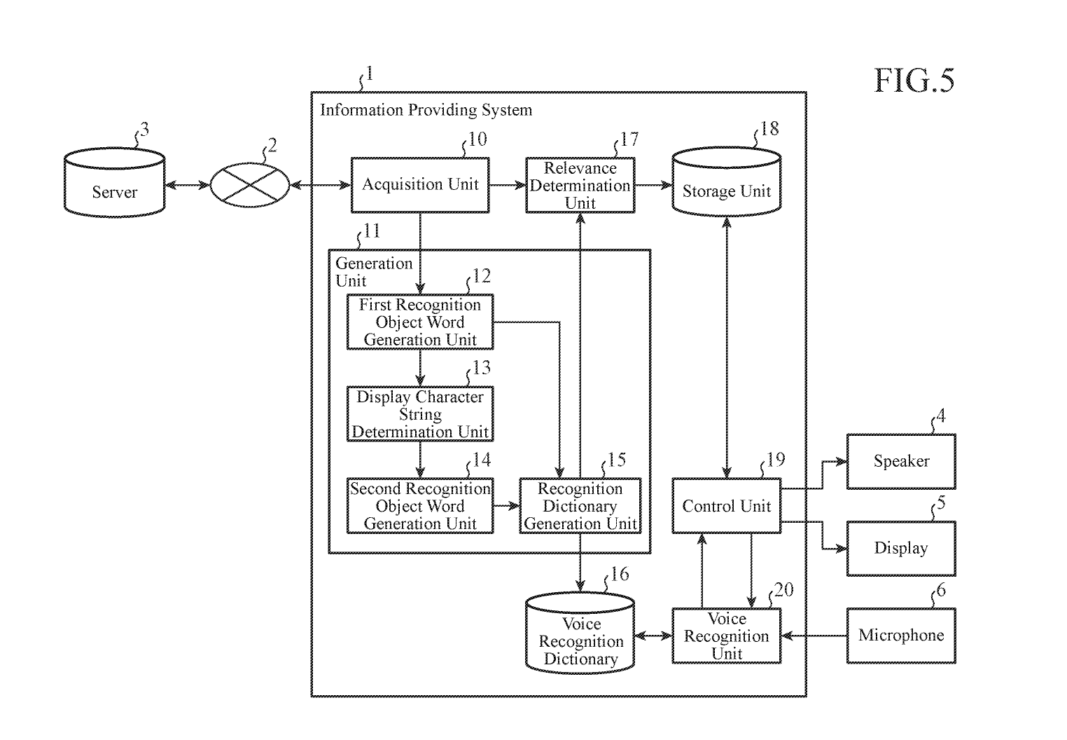

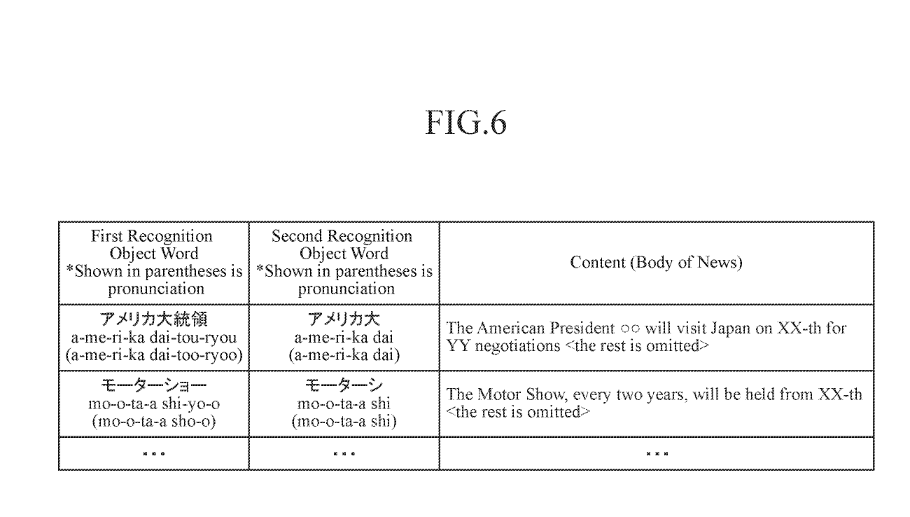

FIG. 4 is a schematic diagram showing a main hardware configuration of the information providing system 1 and the peripheral devices thereof, according to Embodiment 1. To a bus 100, a CPU (Central Processing Unit) 101, a ROM (Read Only Memory) 102, a RAM (Random Access Memory) 103, an input device 104, a communication device 105, an HDD (Hard Disk Drive) 106 and an output device 107, are connected.

The CPU 101 reads out a variety of programs stored in the ROM 102 or the HDD 106 and executes them, to thereby implement a variety of functions of the information providing system 1 in cooperation with respective pieces of hardware. The variety of functions of the information providing system 1 implemented by the CPU 101 will be described later with reference to FIG. 5.

The RAM 103 is a memory to be used when a program is executed.

The input device 104 receives a user input, and is a microphone, an operation device such as a remote controller, a touch sensor, or the like. In FIG. 1, the microphone 6 is illustrated as an example of the input device 104.

The communication device 105 performs communications with information sources such as the server 3 through the network 2.

The HDD 106 is an example of an external storage device. Other than the HDD, examples of the external storage device may include a CD/DVD, flash-memory based storage such as a USE memory, an SD card, etc., and the like.

The output device 107 presents information to a user, and is a speaker, an LCD display, an organic EL (Electroluminescence) or the like. In FIG. 1, the speaker 4 and the display 5 are illustrated as examples of the output device 107.

FIG. 5 is a functional block diagram showing a configuration example of the information providing system 1 according to Embodiment 1.

The information providing system 1 includes an acquisition unit 10, a generation unit 11, a voice recognition dictionary 16, a relevance determination unit 17, a storage unit 18, a control unit 19 and a voice recognition unit 20. The functions of the acquisition unit 10, the generation unit 11, the relevance determination unit 17, the control unit 19 and the voice recognition unit 20 are implemented with the CPU 101 executing programs. The voice recognition dictionary 16 and the storage unit 18 correspond to the RAM 103 or the HDD 106.

It is noted that, the acquisition unit 10, the generation unit 11, the voice recognition dictionary 16, the relevance determination unit 17, the storage unit 18, the control unit 19 and the voice recognition unit 20, that constitute the information providing system 1, may be consolidated in a single device as shown in FIG. 5, or may be distributed over a server, a portable information terminal such as a smartphone, and an in-vehicle device, which are provided on a network.

The acquisition unit 10 acquires a content described in HTML (HyperText Markup Language) or XML (eXtensible Markup Language) format from the server 3 through the network 2. Then, the acquisition unit 10 interprets its details on the basis of the predetermined tag information, etc, given to the acquired content, and extracts information of its main part with processing such as eliminating supplementary information, to thereby output the information to the generation unit 11 and the relevance determination unit 17.

It is noted that, as the network 2, the Internet or a public line for mobile phone or the like, may be used, for example.

The server 3 is an information source in which contents, such as news, are stored. In Embodiment 1, news text information that is acquirable by the information providing system 1 from the server 3 through the network 2 is exemplified as a “content”; however, the content is not limited thereto, and may be knowledge database services such as a word dictionary, etc., or text information of cooking recipes or the like. Further, a content which is not required to be acquired through a network 2 may be used, such as a content, being preliminary stored in the information providing system 1.

Furthermore, the content is not limited to text information, and may be moving image information, audio information or the like.

For example, the acquisition unit 10 acquires news text information distributed from the server 3 at every distribution timing, or acquires text information of cooking recipes stored in the server 3 triggered by a request by a user.

The generation unit 11 includes a first recognition object word generation unit 12, a display character string determination unit 13, a second recognition object word generation unit 14 and a recognition dictionary generation unit 15.

The first recognition object word generation unit 12 extracts from the text information of the content acquired by the acquisition unit 10, the keyword related to this content, to thereby generate the first recognition object word from the keyword. For extracting the keyword, any method may be used, and as an example, the following method can be used: a conventional natural language processing technique such as a morphological analysis is used to thereby extract important words indicative of details of the content, such as, a proper noun included in the text information of that content, the headline of the text information or a leading noun in the body thereof, a noun frequently appearing in the text information, or the like. For example, from the news headline of “The American President, To Visit Japan On XX-th”, the first recognition object word generation unit 12 extracts a leading noun “American President” (a-me-ri-ka dai-tou-ryou) as a keyword, and then sets its notation and pronunciation as the first recognition object word, as “a-me-ri-ka dai-tou-ryou (a-me-ri-ka dai-too-ryoo)”. The first recognition object word generation unit 12 outputs the generated first recognition object word to the display character string determination unit 13 and the recognition dictionary generation unit 15. The keyword and the first recognition object word are the same in notation.

It is noted that the first recognition object word generation unit 12 may add a preset character string to the first recognition object word. For example, a character string “no nyu-su (in English, “news related to”)” may be added to the end of the first recognition object word “a-me-ri-ka dai-tou-ryou” to get “a-me-ri-ka dai-tou-ryou no nyu-su (in English, “News Related to American President”)” as the first recognition object word. The character string to be added to the first recognition object word is not limited thereto, and the character string may be added to either head or end of the first recognition object word. The first recognition object word generation unit 12 may set both “a-me-ri-ka dai-tou-ryou” and “a-me-ri-ka dai-tou-ryou no nyu-su” as the first recognition object words, or may set either one of them as the first recognition object word.

Based on the information of the character display areas A1, A2 of the display 5, the display character string determination unit 13 determines the specified character number displayable in each of these areas. Then, the display character string determination unit 13 determines whether or not the number of characters of the first recognition object word generated by the first recognition object word generation unit 12 exceeds the specified character number, and if it exceeds that number, generates a character string by shortening the first recognition object word to have the specified character number, and outputs the generated character string to the second recognition object word generation unit 14. In Embodiment 1, the character string generated by shortening the first recognition object word to have the specified character number, and the second recognition object word described later, are the same in notation.

The information of the character display areas A1, A2 may be any information, such as the number of characters, the number of pixels or the like, so far as it represents sizes of the areas. Further, the character display areas A1, A2 may have predetermined sizes, or the sizes of the character display areas A1, A2 may vary dynamically when the size of the displayable area or display screen varies dynamically. When the sizes of the character display areas A1, A2 vary dynamically, the information of the character display areas A1, A2 is notified, for example, from the control unit 19 to the display character string determination unit 13.

For example, when the first recognition object word is “a-me-ri-ka dai-tou-ryou (a-me-ri-ka dai-too-ryoo)” and if the specified character number is five, the display character string determination unit 13 deletes the two end characters “tou-ryou” from “a-me-ri-ka dai-tou-ryou” to thereby shorten the word to get the character string “a-me-ri-ka dai (a-me-ri-ka dai)” corresponding to the five characters from the head. The display character string determination unit 13 outputs the character string “a-me-ri-ka dai” obtained by shortening the first recognition object word, to the second recognition object word generation unit 14. Note that in this case, the first recognition object word is shortened to the character string corresponding to the five characters from its head; however, any method may be applied so far as it shortens the first recognition object word to have the specified character number.

On the other hand, when the first recognition object word is “a-me-ri-ka dai-tou-ryou” (a-me-ri-ka dai-too-ryoo)” and the specified character number is seven, the display character string determination unit 13 outputs the character string “a-me-ri-ka dai-tou-ryou” without change to the second recognition object word generation unit 14.

The second recognition object word generation unit 14 generates the second recognition object word when it receives the character string obtained by shortening the first recognition object word to have the specified character number, from the display character string determination unit 13. For example, when the character string obtained by shortening “a-me-ri-ka dai-tou-ryou” is “a-me-ri-ka dai”, the second recognition object word generation unit 14 sets its notation and pronunciation as the second recognition object word, “a-me-ri-ka dai (a-me-ri-ka dai)”. The second recognition object word generation unit 14 generates, as a pronunciation of the second recognition object word, a pronunciation that is, for example, partly included in the pronunciation of the first recognition object word and corresponding to the character string shortened to have the specified character number. The second recognition object word generation unit 14 outputs the generated second recognition object word to the recognition dictionary generation unit 15.

In contrast, when the second recognition object word generation unit 14 receives the non-shortened first recognition object word from the display character string determination unit 13, it does not generate the second recognition object word.

It is noted that in this embodiments the description has been made about a case where one pair of the first recognition object word and the second recognition object word is generated for one content; however, plural pairs of the first recognition object words and the second recognition object words may be generated for one content when there is a plurality of keywords related to the content. Further, it is not required that the number of the first recognition object words is same to the number of the second recognition object words.

The recognition dictionary generation unit 15 receives the first recognition object word from the first recognition object word generation unit 12, and receives the second recognition object word from the second recognition object word generation unit 14. Then, the recognition dictionary generation unit 15 registers the first recognition object word and the second recognition object word in the voice recognition dictionary 16 so that they are included in the recognition vocabulary. Further, the recognition dictionary generation unit 15 outputs the first recognition object word and the second recognition object word to the relevance determination unit 17.

The voice recognition dictionary 16 may be provided in any format, such as, a format of network grammar in which recognizable word strings are written in a grammatical form, a format of statistical language model in which linkages between words are represented by a stochastic model, or the like.

When the microphone 6 collects a voice spoken by the user B and outputs it to the voice recognition unit 20, the voice recognition unit 20 recognizes the speech voice by the user B with reference to the voice recognition dictionary 16, and outputs the recognition result character string to the control unit 19. As a voice recognition method performed by the voice recognition unit 20, any conventional methods can be used, so that its description is omitted here.

In the meanwhile, in some cases, with respect to the voice recognition function installed in an in-vehicle device, such as a car-navigation system, etc., in order for a user B to explicitly indicate starting of speech to the information providing system 1, a button for indicating an instruction for starting voice recognition is provided. In such a case, the voice recognition unit 20 starts to recognize the spoken voice after that button is pressed down by the user B.

When the button for indicating an instruction for starting voice recognition is not provided, for example, the voice recognition unit 20 constantly receives the voice collected by the microphone 6, and detects a speaking period corresponding to the content spoken by the user B, to thereby recognize the voice in the speaking period.

The relevance determination unit 17 receives the text information of the content acquired by the acquisition unit 10 and receives the first recognition object word and the second recognition object word from the recognition dictionary generation unit 15. Then, the relevance determination unit 17 determines correspondence relations among the first recognition object word, the second recognition object word and the content, and stores the first recognition object word and the second recognition object word in the storage unit 18 to be associated with the text information of the content.

In the storage unit 18, the content that is currently available, the first recognition object word, and the second recognition object word are stored to be associated with each other.

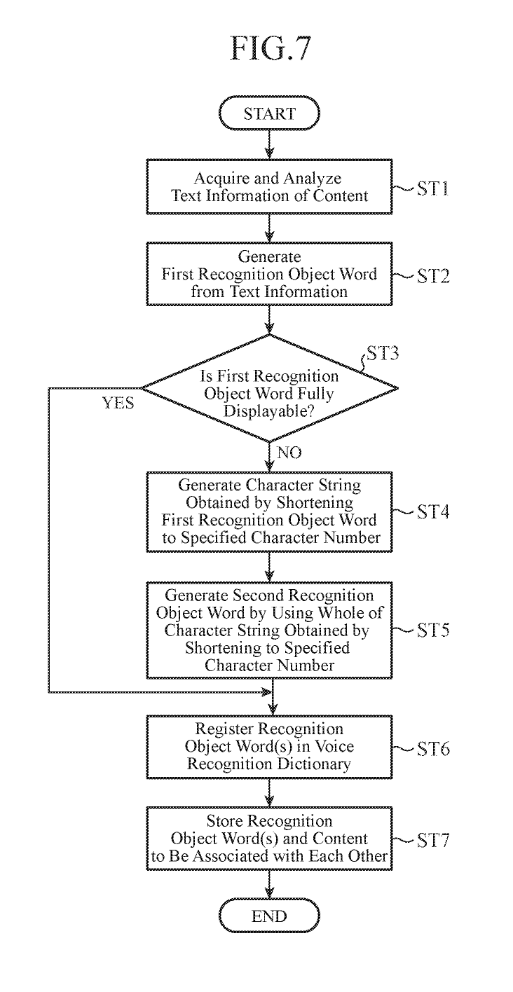

Here, in FIG. 6, an example of the first recognition object word, the second recognition object word, and the content which are stored in the storage unit 18 is shown. FIG. 6 shows an example in a case where the specified character number is five. The first recognition object word “a-me-ri-ka dai-tou-ryou (a-me-ri-ka dai-too-ryoo)”, the second recognition object word “a-me-ri-ka dai (a-me-ri-ka dai)”, and the body of the news, given as a content, “The American President OO will visit Japan on XX-th for YY negotiations <the rest is omitted>”, are associated with each other. In addition, another first recognition object word “mo-o-ta-a shi-yo-o (mo-o-ta-a sho-o)”, another second recognition object word “mo-o-ta-a shi (mo-o-ta-a shi)”, and a body of the news “The Motor Show, every two years, will be held from XX-th <the rest is omitted>”, are associated with each other.

It is noted that, when the number of characters of the first recognition object word is not more than the specified character number, no second recognition object word is generated, so that only the first recognition object word and the content are stored in the storage unit 18 to be associated with each other and.

It is further noted that the content stored in the storage unit 18 is not limited to text information, and may be moving image information, audio information or the like.

The control unit 19 outputs a first recognition object word whose number of characters is not more than the specified character number, or a second recognition object word, to the display 5 and, when the recognition result character string outputted from the voice recognition unit 20 coincides with the first recognition object word or the second recognition object word, acquires information related to that character string from the storage unit 18 and then outputs it to the display 5 or the speaker 4.

In more detail, the control unit 19 acquires the text information of the contents stored in the storage unit 18, and notifies the voice recognition unit 20 of that information as text information of the contents that is currently available. Further, the control unit 19 acquires from the storage unit 18, the second recognition object words stored therein which is associated with the text information of the contents that is currently available, and displays them in their respective character display areas A1, A2 of the display 5 as shown in FIG. 3. The case where the second recognition object word exists in the storage unit 18 is the case where the number of characters of the first recognition object word exceeds the specified character number.

On the other hand, in the case where only a first recognition object word associated with the text information of the contents that is currently available is stored in the storage unit 18 and no second recognition object word is stored, the number of characters of the first recognition object word is not more than the specified character number. In this case, as shown in FIG. 2, the control unit 19 acquires the first recognition object words from the storage unit 18 and displays them in their respective character display areas A1, A2 of the display 5.

Further, the control unit 19 receives the recognition result character string from the voice recognition unit 20, collates the recognition result character string with the first recognition abject words and the second recognition object words stored in the storage unit 18, and then acquires the text information of the content that is associated with the first recognition object word or the second recognition object word coinciding with the recognition result character string.

The control unit 19 synthesizes a voice of the acquired text information of the content, and outputs the voice through the speaker 4. For the voice synthesis, conventional methods can be used, so that its description is omitted here.

Note that, the information may be displayed in any manner so far as a user can recognize information appropriately in accordance with the type of that information. Thus, for example, the control unit 19 may display a beginning part of the text information on the screen of the display 5, or may display the full text of the text information on the screen by scrolling.

Further, when the content is moving image information, the control unit 19 makes the display 5 display the moving image information on the screen. When the content is audio information, the control unit 19 makes the speaker 4 output the audio information by voice.

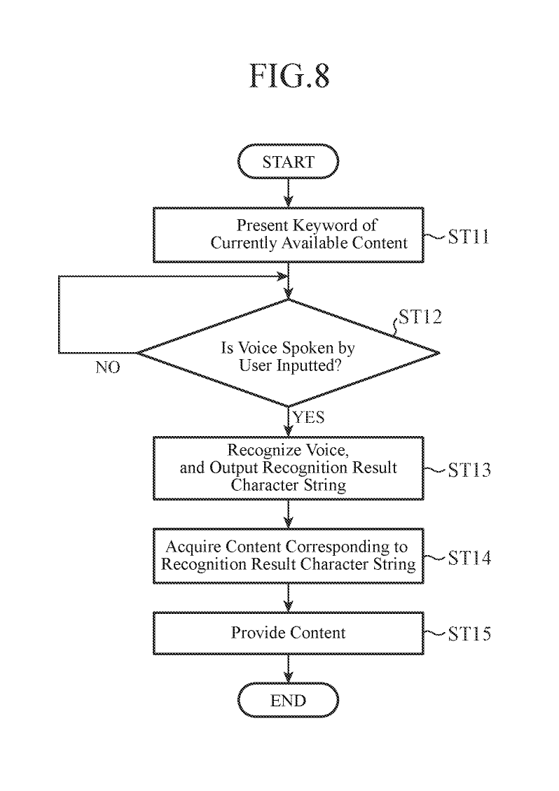

Next, with reference to the flowcharts shown in FIG. 7 and FIG. 8, operations of the information providing system 1 according to Embodiment 1 will be described.

In this explanation, it is assumed that a content distributed from the server 3 for a news providing service is acquired. For simplifying the description, it is assumed that the information providing system 1 acquires two news contents of news-α and news-β distributed by the server 3 through the network 2. With respect to the news-α, the headline is “The American President, To Visit Japan On XX-th”, and the body is “The American President OO will. visit Japan on XX-th for YY negotiations <the rest is omitted>”. With respect to the news-β, the headline is “The Motor Show, Held In Tokyo”, and the body is “The Motor Show, held on every two years, will be held from XX-th <the rest is omitted>”.

At first, operations at the time of acquiring contents will be described with reference to the flowchart shown in FIG. 7.

First, the acquisition unit 10 acquires the contents distributed from the server 3 through the network 2, and eliminates supplementary information of the contents by analyzing their tags and the like, to thereby obtain the text information of main parts, such, as, the headlines, the bodies and the like, of the news-α, β (Step ST1). The acquisition unit 10 outputs the text information of these contents to the first recognition object word generation unit 12 and the relevance determination unit 17.

Subsequently, the first recognition object word generation unit 12 extracts keywords from the text information of the contents acquired from the acquisition unit 10, to thereby generate the first recognition object words (Step ST2). The first recognition object word generation unit 12 outputs the first recognition object words to the display character string determination unit 13 and the recognition dictionary generation unit 15.

Here, the first recognition object word generation unit 12 uses a natural language processing technique, such as a morphological analysis, to thereby extract a noun (as an example, a compound noun is included) that appears at the beginning of the headline of a news as a keyword, and then generates the notation and the pronunciation of the keyword, to thereby set them as the first recognition object word. Namely, in the case of specific examples of the news-α and news-β, the first recognition object word of the news-α is “a-me-ri-ka dai-tou-ryou (a-me-ri-ka dai-too-ryoo)”, and the first recognition object word of the news-β is “mo-o-ta-a shi-yo-o (mo-o-ta-a sho-o)”.

Subsequently, based on the information of the character display areas A1, A2 of the display 5, the display character string determination unit 13 determines the specified character number displayable in each of the character display areas A1, A2, and determines whether or not the number of characters of each of the first recognition object words received from the display character string determination unit 13 exceeds the specified character number, namely, whether or not the characters of the first recognition object words are fully displayable in their respective character display areas A1, A2 (Step ST3). When the characters of a first recognition object word are not fully displayable (Step ST3 “NO”), the display character string determination unit 13 generates a character string which is obtained by shortening the first recognition object word to have the specified character number (Step ST4). The display character string determination unit 13 outputs the character string obtained by shortening the first recognition object word to have the specified character number, to the second recognition object word generation unit 14.

Here, explanation is given with assuming that the specified character number in each of the character display areas A1, A2 is five. By applying this case to the aforementioned specific example, in each case of the news-α and news-β, the first recognition object word cannot be fully displayed because the number of characters exceeds five. Thus, the display character string determination unit 13 shortens the first recognition object word of the news-α to five characters to be “a-me-ri-ka dai”, and shortens the first recognition object word of the news-β to five characters to be “mo-o-ta-a shi” or “mo-o-ta-a sho”. In the following, description will be made assuming that the first recognition object word is shortened to “mo-o-ta-a shi”.

Subsequently, the second recognition object word generation unit 14 receives the character strings obtained by shortening the first recognition object words to have the specified character number from the display character string determination unit 13, and generates the second recognition object words by using all characters included in the character strings (Step ST5). The second recognition object word generation unit 14 generates, as a pronunciation of each of the second recognition object words, a pronunciation that is, for example, partly included in the pronunciation of the first recognition object word and corresponding to the character string obtained by shortening to the specified character number. Namely, by applying this case to the aforementioned specific example, the second recognition object word of the news-α is “a-me-ri-ka dai (a-me-ri-ka dai)”, and the second recognition object word of the news-β is “mo-o-ta-a shi (mo-o-ta-a shi)”. The second recognition object word generation unit 14 outputs these second recognition object words to the recognition dictionary generation unit 15.

On the other hand, when the characters of each of the first recognition object words are fully displayable within the specified character number (Step ST3 “YES”), the display character string determination unit 13 skips the processing of Steps ST4, ST5, and proceeds to Step ST6.

Subsequently, the recognition dictionary generation unit 15 receives the first recognition object words from the first recognition object word generation unit 12, and registers them in the voice recognition dictionary 16 as recognition object words (Step ST6). Further, when the characters of a first recognition object word cannot be fully displayed, the recognition dictionary generation unit 15 receives the second recognition object word from the second recognition object word generation unit 14, and registers the second recognition object word in the voice recognition dictionary 16 also as a recognition object word in addition to the first recognition object word (Step ST6). By applying this case to the aforementioned specific example, the first recognition object words “a-me-ri-ka dai-tou-ryou (a-me-ri-ka dai-too-ryoo)” and “mo-o-ta-a shi-yo-o (mo-o-ta-a sho-o)”, and the second recognition object words “a-me-ri-ka dai (a-me-ri-ka. dai)” and “mo-o-ta-a shi (mo-o-ta-a shi)”, are registered in the voice recognition dictionary 16 as recognition object words.

Furthermore, the recognition dictionary generation unit 15 notifies the relevance determination unit 17 of the recognition object words registered in the voice recognition dictionary 16.

Subsequently, the relevance determination unit 17 receives the text information of the contents from the acquisition unit 10 and receives the notification of the recognition object words from the recognition dictionary generation unit 15, determines respective correspondence relations between the contents and the recognition object words, and stores them in the storage unit 18 in a state where the contents and the recognition object words are associated with each other (Step ST7).

Then, with reference to the flowchart shown in FIG. 8, operations from the presentation of keywords to the provision of a content will be described.

First, the control unit 19 refers to the storage unit 18, and, when a second recognition object word associated with a currently available content is stored therein, acquires that second recognition object word, and displays it as a keyword related to that content, on the character display area A1 or A2 of the display 5 (Step ST11). Further, when no second recognition object word associated with a currently available content is stored and only a first recognition object word is stored therein, the control unit 19 acquires that first recognition object word, and then displays it as a keyword related to that content, in the character display area A1 or A2 of the display 5 (Step ST11). In this manner, the control unit presents a keyword to the user B by displaying the first or second recognition object word in accordance with the size of each of the character display areas A1 and A2 as the keyword.

By applying this case to the aforementioned specific example, because the first recognition object words of the news-α, β cannot fully displayed on the respective character display areas A1, A2, the second recognition object words “a-me-ri-ka dai (a-me-ri-ka dai)” and “mo-o-ta-a shi (mo-o-ta-a shi)” are displayed on the respective character display areas A1, A2 of the display 5.

It is noted that, before or concurrently with presenting the keywords in Step ST11, the control unit 19 may inform the user B of a summary of the news that is currently available, by outputting the headlines or beginning parts of the bodies of the news-α, β, etc. by voice.

After Step ST11, the microphone 6 collects a speech voice by the user B, and outputs it to the voice recognition unit 20.

The voice recognition unit 20 waits for the speech voice by the user B to be inputted through the microphone 6 (Step ST12), and when the speech voice is inputted (Step ST12 “YES”), recognizes that speech voice with reference to the voice recognition dictionary 16 (Step ST13). The voice recognition unit 20 outputs the recognition result character string to the control unit 19.

By applying this case to the aforementioned specific example, when the user B speaks “a-me-ri-ka dai (a-me-ri-ka dai)”, the voice recognition unit 20 recognizes this speech voice with reference to the voice recognition dictionary 16, and outputs “a-me-ri-ka dai” to the control unit 19 as the recognition result character string.

Subsequently, the control unit 19 receives the recognition result character string from the voice recognition unit 20, searches in the storage unit 18 by using the recognition result character string as a search key, to thereby acquire the text information of the content corresponding to the recognition result character string (Step ST14).

By applying this case to the aforementioned specific example, because the recognition result character string of “a-me-ri-ka dai” coincides with the second recognition object word of the news-α “a-me-ri-ka dai (a-me-ri-ka dai)”, the body of the news-α of “The American President OO will visit Japan on XX-th for YY negotiations <the rest is omitted>” is acquired from the storage unit 18.

Subsequently, the control unit 19 synthesizes a voice of the text information of the content acquired from the storage unit 18 to thereby output that information through the speaker 4 by voice, or displays a beginning part of the text information on the screen of the display 5 (Step ST15). Accordingly, the content that the user B desires and attempts to select is provided.

As described above, according to Embodiment 1, the information providing system 1 is configured to includes: the acquisition unit 10 for acquiring from the server 3, a content to be provided; the generation unit 11 for generating the first recognition object word from the content acquired by the acquisition unit 10, and for generating the second recognition object word by using every character string which is obtained by shortening the first recognition object word, when its number of characters exceeds the specified character number, to that specified character number; the storage unit 18 for storing the content acquired by the acquisition unit 10, and the first recognition object word and the second recognition object word generated by the generation unit 11, as they are associated with each other; the voice recognition unit 20 for recognizing a speech voice by the user B to thereby output a recognition result character string; and the control unit 19 for outputting the first recognition object word or the second recognition object word which has been generated by the generation unit 11 and is composed of a character string whose number of characters is not more than the specified character number, to the display 5, and for acquiring, when the recognition result character string outputted from the voice recognition unit 20 coincides with the first recognition object word or the second recognition object word, the content related to that string from the storage unit 18, and then outputting it to the display 5 or the speaker 4. Thus, even when the user B, to whom the first recognition object word or the second recognition object word composed of a character string whose number of characters is not more than the specified character number is presented, falsely recognizes the presented character string and speaks a word other than the first recognition object word, the recognition can be performed on the basis of the second recognition object word. Accordingly, it becomes possible to provide the information that the user B desires and attempts to select, to thereby enhance operability and convenience.

The second recognition object word generation unit 14 of Embodiment 1 is configured to use the character string obtained by shortening the first recognition object word being a keyword to have the specified character number, as the second recognition object word, without change; however, the shortened character string may be subject to a certain process to generate a second recognition object word.

In the following, modified examples regarding the generation method of the second recognition object word will be described.

For example, the second recognition object word generation unit 14 may generate one or more pronunciations for the character string which is obtained by shortening the first recognition object word to have the specified character number, each as a pronunciation of the second recognition object word. In this case, for example, the second recognition object word generation unit 14 performs morphological analysis processing to thereby determine the one or more pronunciations, or uses a word dictionary, which is not shown in the drawings, or the like to thereby determine the one or more pronunciations.

Specifically, the second recognition object word generation unit 14 gives the second recognition object word “a-me-ri-ka dai”, in addition to or instead of “a-me-ri-ka dai (a-me-ri-ka dai, which is a pronunciation of the Japanese character string)” that is the same as the first recognition object word in pronunciation, a pronunciation such as “a-me-ri-ka dai (a-me-ri-ka o-o, which is another possible pronunciation of the same Japanese character string)”, “a-me-ri-ka dai (a-me-ri-ka tai, which is further another possible pronunciation of the same Japanese character string)” and the like.

This increases the possibility that, even when the user B speaks with a pronunciation different to the pronunciation of the first recognition object word, the content that the user B desires and attempts to select is provided to the user. Thus, the operability and convenience of the user B are further enhanced.

Further, for example, the second recognition object word generation unit 14 may generate a pronunciation of a second recognition object word by adding a pronunciation of another character string to the pronunciation of the character string which is obtained by shortening the first recognition object word to have the specified character number. In this case, for example, the second recognition object word generation unit 14 searches another character string mentioned above with reference to a word dictionary which is not shown in drawings, or the like. The pronunciation of the generated second recognition object word becomes a pronunciation of another word in which the character string obtained by the shortening is fully included.

Specifically, the second recognition object word generation unit 14 adds another character string “riku” (a word which means “land” in Japanese) to the character string “a-me-ri-ka dai” obtained by shortening “a-me-ri-ka dai-tou-ryou”, to thereby generate a character string “a-me-ri-ka dai-riku”, and sets the pronunciation (a-me-ri-ka tai-riku) (which means “American Continent (Large Land)” in Japanese) of the generated “a-me-ri-ka dai-riku” as a pronunciation of the second recognition object word “a-me-ri-ka dai”.

This increases the possibility that, even when the user B speaks with a pronunciation different to the pronunciation of the first recognition object word, the content that the user B desires and attempts to select is provided to the user. Thus, the operability and convenience of the user B are further enhanced.

Further, for example, the second recognition object word generation unit 14 may generate another second recognition object word, by substituting the character string obtained by shortening the first recognition object word to have the specified character number, with another character string whose number of characters is not more than the specified character number and which is synonymous with the first recognition object word. In this case, for example, the second recognition object word generation unit 14 searches the other character string whose number of characters is not more than the specified character number and which is synonymous with the first recognition object word with reference to a word dictionary, which is not shown in drawings, or the like.

Specifically, with respect to the first recognition object word “a-me-ri-ka dai-tou-ryou (a-me-ri-ka dai-too-ryoo)”, the second recognition object word generation unit 14 generates, as a second recognition object word, a character string of “bei-koku dai-tou-ryou (bei-koku dai-too-ryoo)” (which means “American President” in Japanese) whose number of characters is not more than the specified character number of five and which is synonymous with the first recognition object word. The second recognition object word generation unit 14 sets “bei-koku dai-tou-ryou”, in addition to “a-me-ri-ka dai”, as a second recognition object word.

This increases the possibility that, even when the user B speaks with a pronunciation different to the pronunciation of the first recognition object word, the content that the user B desires and attempts to select is provided to the user. Thus, the operability and convenience of the user B are further enhanced.

Furthermore, as the character string to be presented as a keyword to the user B, the control unit 19 may not use the character string of “a-me-ri-ka dai” obtained by shortening the first recognition object word to have the specific character number, but may substitute it to the notation of another second recognition object word “bei-koku dai-tou-ryou” to thereby change the character string to be presented to the user B.

Further, for example, the second recognition object word generation unit 14 may generate a plurality of second recognition object words according to any combination of the modification examples described above.

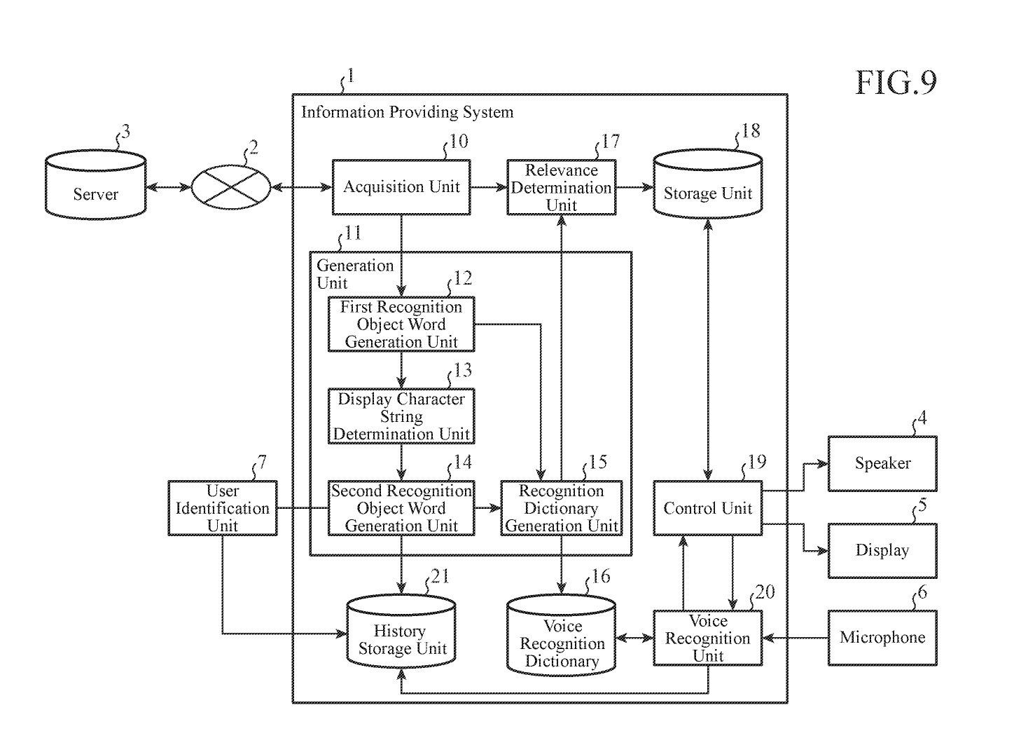

Moreover, for example, the second recognition object word generation unit 14 may generate a pronunciation of the second recognition object word on the basis of a speech history of the user B. A configuration example of the information providing system 1 in this case is shown in FIG. 9.

In FIG. 9, a history storage unit 21 is added in the information providing system 1. The history storage unit 21 stores the respective recognition result character strings of the voice recognition unit 20 as a speech history of the user B. The second recognition object word generation unit 14 acquires the recognition result character string stored in the history storage unit 21 to thereby set it as a pronunciation of the second recognition object word.

Specifically, in the case where two types of the second recognition object words “a-me-ri-ka dai (a-me-ri-ka dai)” and “a-me-ri-ka dai (a-me-ri-ka o-o)” are generated, and when the user B speaks “a-me-ri-ka dai (a-me-ri-ka dai)”, thereafter, the second recognition object word generation unit 14 generates the second recognition object word “a-me-ri-ka dai (a-me-ri-ka dai)” to which the pronunciation of the speech previously made by the user B is given.

At this processing, the second recognition object word generation unit 14 may be configured to perform statistical processing, such as frequency distribution processing or the like, to thereby give a pronunciation used with a predetermined probability or more, to the second recognition object word, in a manner not merely depending on the fact that the user B previously spoke or not.

This makes it possible to reflect habits in speaking by the user B to the voice recognition processing, thereby increasing the possibility that, even when the user B speaks with a pronunciation different to the pronunciation of the first recognition object word, the content that the user B desires and attempts to select is provided to the user. Thus, the operability and convenience of the user B are further enhanced.

Furthermore, the second recognition object word generation unit 14 may generate second recognition object words in accordance with users, respectively, based on the speech history of the users. In this case, for example, as shown in FIG. 9, a user identification unit 7 identifies a current user B, and outputs the identification result to the second recognition object word generation unit 14 and the history storage unit 21. The history storage unit 21 stores the recognition result character string being associated with the user B notified from the user identification unit 7. The second recognition object word generation unit 14 acquires from the history storage unit 21, the recognition result character string stored as associated with the user B notified from the user identification unit 7, and sets it as a pronunciation of the second recognition object word.

As an identifying method performed by the user identification unit 7, any method can be used so far as it can identify the user, such as, login authentication which requires a user to input a user name, a password or the like, biometric authentication based on the user's face, fingerprint, etc., or the like.

Meanwhile, although the first recognition object word and the second recognition object word generated according to operations shown in the flowchart of FIG. 7 are registered in the voice recognition dictionary 16, at least the second recognition object word may be deleted at a preset timing, for example, when the acquisition unit 10 acquires a new content, when the serve 3 stops providing an old content, or when a preset time comes.

The case when a preset time comes means, for example, a timing after elapse of a predetermined time period (for example, 24 hours) from the time the second recognition object word is registered in the voice recognition dictionary 16, a timing where a predetermined clock time (for example, 6o'clock every morning) comes, or the like. Furthermore, a configuration in which the timing for deleting the second recognition object word from the voice recognition dictionary 16 is set by a user may be adopted.

Accordingly, the recognition object word that is less likely to spoken by the user B can be deleted, so that it is possible to reduce the area to be used in the RAM 103 or HDD 106 that constitutes the voice recognition dictionary 16.

On the other hand, when the recognition object word registered in the voice recognition dictionary 16 is not deleted, the following processing may be performed in order to reduce the time for recognition processing: for example, the voice recognition unit 20 receives the text information of the content that is currently available from the control unit 19, and activates, among the first recognition object words and the second recognition object words registered in the voice recognition dictionary 16, the first recognition object word and the second recognition object word corresponding to the received text information of the content, to thereby specify the recognizable vocabulary.

Further, the control unit 19 of Embodiment 1 is configured to perform the control of displaying the first recognition object words or the character strings obtained by shortening the first recognition object words to have the specified character number on the screen; however, the control unit 19 may control the display 5 to display each of these character strings to function as a software key selectable by the user B. As the software key, any type may be used so far as the user B can perform selection operation using the input device 104. For example, a touch button device through which a selection can be performed with a touch sensor, a button device through which a selection can be performed with an operation device, and the like can be used as the software key.

Further, although the information providing system 1 according to Embodiment 1 is configured for the case where the recognition object word is a word in Japanese, it may be configured for the case of a language other than Japanese.

It should be noted that, other than the above, modification of any configuration element in the embodiments and omission of any configuration element in the embodiments may be made in the present invention without departing from the scope of the invention.

### INDUSTRIAL APPLICABILITY

The information providing system according to the invention is so configured to generate, in addition to generate the first recognition object word from the information to be provided, the second recognition object word by using whole of the character string obtained by shortening the first recognition object word to have the specified character number, so that it is suited to be used in an in-vehicle device, a portable information terminal or the like in which the number of displayable characters on its screen is limited.

### REFERENCE SIGNS LIST

1: information providing system, 2: network, 3: server (information source), 4; speaker (audio output unit), 5: display (display unit), 6: microphone, 7: user identification unit, 10: acquisition unit, 11: generation unit, 12: first recognition object word generation unit, 13: display character string determination unit, 14: second recognition object word generation unit, 15: recognition dictionary generation unit, 16: voice recognition dictionary, 17: relevance determination unit, 18: storage unit, 19: control unit, 20: voice recognition unit, 21: history storage unit, 100: bus, 101: CPU, 102: ROM, 103: RAM, 104: input device, 105: communication device, 106: HDD, 107: output device

1. An information providing system, comprising:
acquisitor acquiring information being an object to be provided from an information source;
a generator generating a first recognition object word from the information acquired by the acquisitor, and generating a second recognition object word by using whole of a character string which is obtained by shortening the first recognition object word to have a specified character number when the number of characters of the first recognition object word exceeds the specified character number;
a storage storing the information acquired by the acquisitor, being associated with the first recognition object word and the second recognition object word generated by the generator;
a voice recognizer recognizing a speech voice by a user to output a recognition result character string; and
a controller outputting the first recognition object word or the second recognition object word which is generated by the generator and is composed of a character string whose number of characters is not more than the specified character number, to a display, and acquiring, when the recognition result character string outputted from the voice recognizer coincides with the first recognition object word or the second recognition object word, the information associated with the first recognition object word or the second recognition object word from the storage, and outputting the acquired information to the display or an audio outputter.

2. The information providing system according to claim 1, wherein the generator generates the second recognition object word by processing the character string which is obtained by shortening the first recognition object word to have the specified character number.

3. The information providing system according to claim 2, wherein the generator generates, as a pronunciation of the second recognition object word, a pronunciation that is a part of a pronunciation of the first recognition object word and corresponds to the character string obtained by the shortening to have the specified character number.

4. The information providing system according to claim 2, wherein the generator generates one or more pronunciations for the character string obtained by shortening the first recognition object word to have the specified character number, each as a pronunciation of the second recognition object word.

5. The information providing system according to claim 2, wherein the generator generates a pronunciation of the second recognition object word, by adding a pronunciation of another character string to a pronunciation of the character string obtained by shortening the first recognition object word to have the specified character number.

6. The information providing system according to claim 1, wherein the generator generates another second recognition object word, by substituting the character string obtained by shortening the first recognition object word to have the specified character number, with another character string whose number of characters is not more than the specified character number and which is synonymous with the first recognition object word.

7. The information providing system according to claim 2, wherein the generator generates a pronunciation of the second recognition object word on the basis of a speech history of the user.

8. The information providing system according to claim 1, wherein the generator registers the first recognition object word and the second recognition object word in a voice recognition dictionary, and deletes at least the second recognition object word from the voice recognition dictionary when the acquisitor acquired new information or a preset time comes.
